(19) United States
(12) Patent Application Publication
(10) Pub. No.: US 2026/0211488 A1
(43) Pub. Date: Jul. 23, 2026

(54) METHOD AND APPARATUS FOR DETERMINING RELATIVE POSE, EXTENDED REALITY SYSTEM, DEVICE, AND MEDIUM

(71) Applicant: BEIJING UNICORN TECHNOLOGY CO., LTD., Beijing (CN)

(72) Inventors: Xianwei Lv, Beijing (CN); Kejian Wu, Beijing (CN)

(21) Appl. No.: 19/144,500

(22) PCT Filed: Dec. 21, 2023
(86) PCT No.: PCT/CN2023/140605

§ 371 Date: Jun. 29, 2025

(30) Foreign Application Priority Data
Dec. 30, 2022 (CN) 202211726270.1

(51) Int. Cl. G06F 3/01; G06F 3/0346

(52) U.S. Cl. CPC G06F 3/012; G06F 3/0346

(57) ABSTRACT

Embodiments of the present disclosure disclose a method and apparatus for determining a relative pose, an extended reality system, a device, and a medium. An auxiliary positioning apparatus and a target head-mounted display device corresponding to the auxiliary positioning apparatus are located inside a movable carrier, and the auxiliary positioning apparatus is fixedly connected to the carrier. The method includes: obtaining an image of a user wearing the target head-mounted display device captured by an image sensor, first inertial data captured by a first inertial measurement unit, and second inertial data captured by a second inertial measurement unit; determining, based on the image, pose data of the target head-mounted display device relative to the auxiliary positioning apparatus; performing data fusion on the first inertial data, the second inertial data, and the pose data, and perform fusion detection; and when the fusion detection passes, determining a relative pose of the target head-mounted display device relative to the carrier based on the first inertial data, the second inertial data, and the pose data.

The present disclosure claims priority to Chinese Patent Application No. CN202211726270.1, filed with the China National Intellectual Property Administration on Dec. 30, 2022, and entitled “Method and Apparatus for Determining Relative Pose, Extended Reality System, Device, and Medium”, which is incorporated herein by reference in its entirety.

### TECHNICAL FIELD

The present disclosure relates to extended reality technology, and in particular, to a method and apparatus for determining a relative pose, an extended reality system, a device, and a medium.

### BACKGROUND

At present, extended reality technology has been widely applied to various fields such as healthcare, retail, education, social media, and entertainment, to enhance user experience.

Extended reality, which may include augmented reality, virtual reality, mixed reality, and the like, can provide a user with an extended reality experience by rendering virtual content, or integrating rendered virtual content with a physical world, and allows the user to interact with a real or physical environment that is augmented by using the virtual content.

When the user wears a head-mounted display device in a movable carrier (e.g., an automobile), there is relative movement between the head-mounted display device and the carrier due to a difference in motion states between the user and the carrier.

In the related art, in order to distinguish between movement of the user's head and movement of the carrier, typically, image data and inertial data are respectively captured by using a visual sensor and an inertial measurement apparatus provided on the head-mounted display device, and a relative pose of the head-mounted display device relative to the carrier is calculated, thereby characterizing the relative movement between the head-mounted display device and the carrier.

### SUMMARY

Embodiments of the present disclosure provide a method and apparatus for determining a relative pose, an extended reality system, a device, and a medium.

In an aspect of embodiments of the present disclosure, a method for determining a relative pose is provided. The method is applied to an auxiliary positioning apparatus. The auxiliary positioning apparatus and a target head-mounted display device corresponding to the auxiliary positioning apparatus are located inside a movable carrier; the auxiliary positioning apparatus is fixedly connected to the carrier and provided with an image sensor and a first inertial measurement unit; and the target head-mounted display device is provided with a second inertial measurement unit. The method includes: obtaining an image of a user wearing the target head-mounted display device captured by the image sensor, first inertial data captured by the first inertial measurement unit, and second inertial data captured by the second inertial measurement unit; determining, based on the image, pose data of the target head-mounted display device relative to the auxiliary positioning apparatus; performing data fusion on the first inertial data, the second inertial data, and the pose data, and performing fusion detection; and when the fusion detection passes, determining a relative pose of the target head-mounted display device relative to the carrier based on the first inertial data, the second inertial data, and the pose data.

In another aspect of embodiments of the present disclosure, an apparatus for determining a relative pose is provided. The apparatus is applied to an auxiliary positioning apparatus. The auxiliary positioning apparatus and a target head-mounted display device corresponding to the auxiliary positioning apparatus are located inside a movable carrier; the auxiliary positioning apparatus is fixedly connected to the carrier and provided with an image sensor and a first inertial measurement unit; and the target head-mounted display device is provided with a second inertial measurement unit. The apparatus includes: a data obtaining unit configured to obtain an image of a user wearing the target head-mounted display device captured by the image sensor, first inertial data captured by the first inertial measurement unit, and second inertial data captured by the second inertial measurement unit; a pose prediction unit configured to determine, based on the image, pose data of the target head-mounted display device relative to the auxiliary positioning apparatus; a data fusion unit configured to perform data fusion on the first inertial data, the second inertial data, and the pose data, and perform fusion detection; and a pose determination unit configured to, when the fusion detection passes, determine a relative pose of the target head-mounted display device relative to the carrier based on the first inertial data, the second inertial data, and the pose data.

In yet another aspect of embodiments of the present disclosure, there is provided an extended reality system including an auxiliary positioning apparatus, a head-mounted display device, and an apparatus for determining a relative pose, wherein the auxiliary positioning apparatus is fixedly connected to a movable carrier and provided with an image sensor and a first inertial measurement unit, and the head-mounted display device is provided with a second inertial measurement unit; and when the head-mounted display device and the auxiliary positioning apparatus are located inside the movable carrier, the apparatus for determining a relative pose determines a relative pose of the head-mounted display device relative to the carrier by using the method in the above embodiment, so that the head-mounted display device generates a projected image based on the relative pose.

In a still another aspect of embodiments of the present disclosure, there is provided an electronic device including: a memory configured to store a computer program; and a processor configured to execute the computer program stored in the memory, wherein the computer program, when executed, implements the method in any of the above embodiments.

In a further aspect of the present disclosure, there is provided a computer-readable storage medium configured to store a computer program therein, wherein the computer program, when executed by a processor, implements the method in any of the above embodiments.

The technical solution of the present disclosure is further described in detail below in conjunction with the accompanying drawings and embodiments.

### BRIEF DESCRIPTION OF THE DRAWINGS

The drawings constituting a part of the specification describe embodiments of the present disclosure, and together with the description, serve to explain the principle of the present disclosure. With reference to the accompanying drawings, the present disclosure can be understood more clearly according to the following detailed description, in which:

FIG. 1 is a schematic architectural diagram of an extended reality system in some embodiments of the present disclosure;

FIG. 2 is a schematic diagram of a scene to which an extended reality system in some embodiments of the present disclosure is applicable;

FIG. 3 is a schematic flow diagram of some embodiments of a method for determining a relative pose in the present disclosure;

FIG. 4 is a schematic flow diagram of fusion detection in some embodiments of a method for determining a relative pose in the present disclosure;

FIG. 5 is a schematic flow diagram of some embodiments of a method for determining a relative pose in the present disclosure;

FIG. 6 is a schematic flow diagram of other embodiments of a method for determining a relative pose in the present disclosure;

FIG. 7 is a schematic structural diagram of some embodiments of an apparatus for determining a relative pose in the present disclosure; and

FIG. 8 is a schematic structural diagram of some application embodiments of an electronic device in the present disclosure.

### DETAILED DESCRIPTION

Various exemplary embodiments of the present disclosure will now be described in detail with reference to the accompanying drawings. It is to be noted that unless specifically stated otherwise, the relative arrangement of components and steps, numerical expressions and numerical values set forth in these embodiments do not limit the scope of the present disclosure.

It may be understood by those skilled in the art that the terms “first”, “second” and the like in the embodiments of the present disclosure are only used to distinguish between different steps, devices or modules, etc., and do not represent any particular technical meaning or indicate an inevitable logical order thereof.

It should also be understood that in embodiments of the present disclosure, “plurality” may refer to two or more, and “at least one” may refer to one, two, or more.

It should also be understood that the number of any component, data, or structure mentioned in embodiments of the present disclosure may generally be understood to be one or more, unless explicitly defined or indicated otherwise by the context.

Additionally, the term “and/or” in the present disclosure merely represents an association relationship describing associated objects, indicating there may be three relationships. For example, A and/or B may indicate three situations: A exists alone; both A and B exist; and B exists alone. Additionally, the character “/” in the present disclosure generally indicates that the associated objects prior to and following it are in an “or” relationship.

It should also be understood that description of the various embodiments in the present disclosure emphasizes differences between the various embodiments. For their identical aspects or similarities, reference may be made to each other, and for the sake of brevity, they will not be described repeatedly.

Furthermore, it should be appreciated that, for ease of description, the sizes of various parts shown in the drawings are not drawn according to actual proportional relationships.

The following description of at least one exemplary embodiment is actually only illustrative, and in no way serves as any limitation on the present disclosure and its application or use.

Technologies, methods, and devices known to those of ordinary skill in the related art may be not discussed in detail, but where appropriate, the technologies, methods, and devices should be regarded as part of the specification.

It should be noted that similar reference numerals and letters denote similar items in the following drawings, so once a certain item is defined in one drawing, it does not need to be further discussed in subsequent drawings.

Embodiments of the present disclosure may be applied to electronic devices of extended reality types, which may be, for example, AR glasses and VR glasses, and may also be applied to terminal devices loaded with extended reality application software and/or virtual reality application software, which may be, for example, smartphones, tablet computers, and the like. A method disclosed in the present application may be run on a head-mounted display device, a target auxiliary positioning apparatus, or other electronic devices such as an in-vehicle system, which is not uniquely limited herein. It may be understood that an apparatus disclosed in the present application may also be correspondingly provided in a head-mounted display device, a target auxiliary positioning apparatus, or other electronic devices such as an in-vehicle system.

The present disclosure provides a method, apparatus, system, electronic device, and computer-readable storage medium that can be used in a scene in which an immersive extended reality experience is provided in a movable carrier, to enable an extended reality system to distinguish between movement of a user and movement of the movable carrier in which the user is located, so that content of virtual images matches movement perceived by the user.

In practice, in the case where a plurality of groups of head-mounted display devices and auxiliary positioning apparatuses are included inside the same carrier, when a visual sensor of a head-mounted display device is used to photograph an image of an auxiliary positioning apparatus, it is susceptible to interference from auxiliary positioning apparatuses corresponding to other head-mounted display devices, resulting in a problem of identification conflict between the plurality of groups of head-mounted display devices and auxiliary positioning apparatuses, which affects the calculation accuracy of pose data. In a method for determining a relative pose of the present disclosure, an image of a user wearing a head-mounted display device is photographed by using an image sensor, and pose data of the head-mounted display device relative an auxiliary positioning apparatus is predicted, and whether a target head-mounted display device corresponding to the auxiliary positioning apparatus is present in the pose data is determined through fusion detection, thereby solving the problem of identification conflict and helping improve the calculation accuracy of pose data.

In some optional embodiments, a method for determining a relative pose is provided, for determining a relative pose of a target head-mounted display device relative to a carrier. The target head-mounted display device is communicatively connected to an auxiliary positioning apparatus, and the auxiliary positioning apparatus is configured to be fixed to the carrier. The method for determining a relative pose includes: obtaining an image including at least one head-mounted display device captured by an image sensor, first inertial data of at least one target head-mounted display device, and second inertial data of the auxiliary positioning apparatus; determining, based on the image, pose data of each head-mounted display device relative to the auxiliary positioning apparatus; performing data fusion on the first inertial data, the second inertial data, and the pose data, and performing fusion detection, to determine whether a target head-mounted display device is included in the image; in the case where at least one target head-mounted display device is included in the image, determining a relative pose of each target head-mounted display device relative to the carrier based on the first inertial data of each target head-mounted display device, the second inertial data of the auxiliary positioning apparatus, and the determined pose data of each target head-mounted display device relative to the auxiliary positioning apparatus.

Optionally, the head-mounted display device may include an inertial measurement unit, which may detect inertial data of the head-mounted display device. A first inertial measurement unit on the target head-mounted display device may detect the first inertial data of the target head-mounted display device.

In some optional embodiments, a method of determining a relative pose is provided, including: obtaining an image including at least one head-mounted display device captured by an image sensor, first inertial data of at least one target head-mounted display device, and second inertial data of an auxiliary positioning apparatus, wherein the auxiliary positioning apparatus corresponds to the at least one target head-mounted display device; determining, based on the captured image, pose data of each head-mounted display device in the image relative to the auxiliary positioning apparatus; for any target head-mounted display device, performing data fusion on the first inertial data of the target head-mounted display device, the second inertial data, and each pose data, wherein a fusion result of the data fusion is used to characterize whether the target head-mounted display device is included in the image; in response to the image including at least one target head-mounted display device, determining, for any target head-mounted display device included in the image, first inertial data of the target head-mounted display device and pose data of the target head-mounted display device relative to the auxiliary positioning apparatus; and determining a relative pose of the target head-mounted display device relative to the carrier based on the first inertial data of the target head-mounted display device and the pose data of the target head-mounted display device relative to the auxiliary positioning apparatus, and the second inertial data.

It may be understood that the at least one head-mounted display device included in the image captured by the image sensor may or may not include a target head-mounted display device. In the case where a target head-mounted display device is included in the image, one target head-mounted display device may be included, or a plurality of target head-mounted display devices may be included.

### Exemplary System

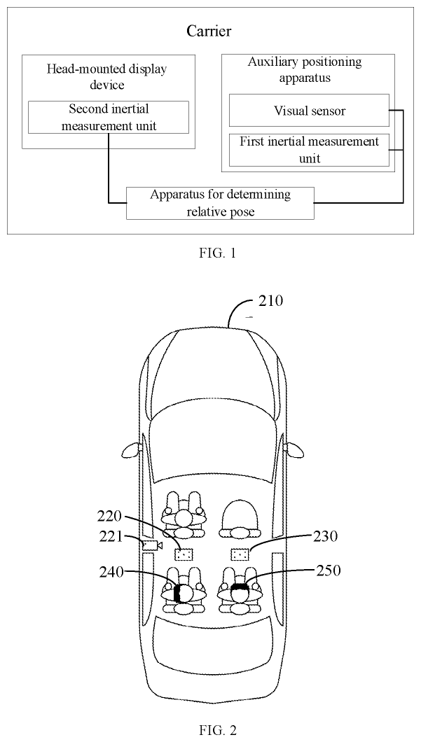

FIG. 1 illustrates an extended reality system in some embodiments of the present disclosure, including: a head-mounted display device, an auxiliary positioning apparatus, and an apparatus for determining a relative pose, wherein the head-mounted display device is provided with a second inertial measurement unit, and the auxiliary positioning apparatus includes an image sensor and a first inertial measurement unit. The first inertial measurement unit may be directly provided on the auxiliary positioning apparatus, or may be provided outside a body of the auxiliary positioning apparatus in a split manner, for example, may be fixed on a movable carrier; or an inertial measurement unit of the movable carrier may be directly used as the second inertial measurement unit of the auxiliary positioning apparatus. The apparatus for determining a relative pose may be provided in the head-mounted display device, or may be provided on the auxiliary positioning apparatus, or may be provided on other electronic devices, such as a smartphone. The apparatus for determining a relative pose may estimate a posture of a user relative to the carrier based on received data, so that the head-mounted display device generates a projected image based on provided pose data, thereby providing an immersive extended reality experience.

In the present application, the above-mentioned auxiliary positioning apparatus may be a split-type device or an integrated device, which is not uniquely limited herein. In the case where the above-mentioned auxiliary positioning apparatus is a split-type device, the first inertial measurement unit and the image sensor, etc. in the auxiliary positioning apparatus may be separate structures, and in this case, the first inertial measurement unit as a separate structure may be separately fixed to the movable carrier. For example, the first inertial measurement unit may be an inertial sensing device, or the first inertial measurement unit may also be an IMU built into the movable carrier.

The above-mentioned extended reality system may also be applied to the movable carrier. In this case, the auxiliary positioning apparatus may be removably fixed to the movable carrier. The movable carrier may include any type of transportation means or mobile environment, such as a vehicle, an airplane, a train, a vessel, an elevator, an amusement park ride, or the like.

In some embodiments, the apparatus for determining a relative pose may include: a data acquisition unit, a pose prediction unit, a data fusion unit, and a pose determination unit.

The data acquisition unit may receive data from one or more of the image sensor, a motion sensor, and an external sensor. Optionally, the image sensor may include any suitable type and number of camera, such as a depth camera, an RGB camera, or a combination thereof, for capturing image data. The motion sensor may be one or more inertial measurement units (IMUs), for acquiring inertial data of the auxiliary positioning apparatus. The external sensor may include a motion sensor provided on the head-mounted display device, for acquiring inertial data of the head-mounted display device.

The pose prediction unit may be configured to predict pose data of the head-mounted display device relative to the auxiliary positioning apparatus based on the image data obtained from the image sensor.

The data fusion unit that may be configured to fuse the data obtained from the motion sensor and the external sensor with the pose data and perform fusion detection.

The pose determination unit may be configured to fuse the data obtained from the motion sensor and the external sensor with the pose data when the fusion detection passes, to determine a relative pose of the head-mounted display device relative to the carrier. Optionally, fusion calculation of the pose data may be performed by using an EKF algorithm (Extended Kalman Filter) or a Gauss-Newton optimization method, or may be modeled as a nonlinear least squares problem.

In such embodiments, a new method for determining a relative pose is proposed, in which an image of a user wearing a head-mounted display device is photographed by an image sensor provided on an auxiliary positioning apparatus, and pose data of the head-mounted display device relative to the auxiliary positioning apparatus is predicted, then fusion detection is performed on first inertial data of the auxiliary positioning apparatus, second inertial data of the head-mounted display device, and the pose data, and when the detection passes, a relative pose of the head-mounted display device relative to a carrier is determined by using a multi-sensor fusion method. This can solve the identification conflict problem that occurs when a plurality of users use auxiliary positioning apparatuses and head-mounted display devices at the same time, improve the accuracy of the determined relative pose, and help improve a displaying effect of subsequent image rendering based on the relative pose.

FIG. 2 shows a diagram of a scene to which an extended reality system in some embodiments of the present disclosure is applicable. As shown in FIG. 2, in this application scene, a carrier 210 may be a vehicle. An auxiliary positioning apparatus 220 and an auxiliary positioning apparatus 230 are fixed inside the carrier 210. The auxiliary positioning apparatus 220 and the auxiliary positioning apparatus 230 are both provided with a first inertial measurement unit (not shown in the figure). An image sensor 221 may be an image sensor of the auxiliary positioning apparatus 220. An image sensor of the auxiliary positioning apparatus 230 is not shown. A head-mounted display device 240 and a head-mounted display device 250 are both provided with a second inertial measurement unit (not shown in the figure). For the split-type device composed of the image sensor 221 and the auxiliary positioning apparatus 220 in FIG. 2, it may be understood that the image sensor 221 and the auxiliary positioning apparatus 220 may also form an integrated device.

The auxiliary positioning apparatus 220 is used as an example in the following description. When a wearer of the head-mounted display device 240 and a wearer of the head-mounted display device 250 are located inside the carrier 210, the image sensor 221 may photograph an image of the wearer of the head-mounted display device 240 and the wearer of the head-mounted display device 250, and at the same time, the first inertial measurement unit of the auxiliary positioning apparatus 220 may acquire first inertial data of the auxiliary positioning apparatus, and the second inertial measurement unit of the head-mounted display device 240 may acquire second inertial data. After obtaining the image, an apparatus for determining a relative pose may predict, based on the image, poses of the head-mounted display device 240 and the head-mounted display device 250 relative to the auxiliary positioning apparatus 220, respectively, and use the obtained 2 poses as pose data of a target head-mounted display device, and perform fusion detection on the first inertial data and the second inertial data with the poses of the head-mounted display device 240 and the head-mounted display device 250, respectively, to determine whether a usable pose (i.e., a pose of a head-mounted display device 240 associated with the auxiliary positioning apparatus 220) is included in the pose data. When the fusion detection passes, the pose data, the first inertial data, and the second inertial data may be fused to determine a relative pose of the target head-mounted display device relative to the carrier.

### Exemplary Method

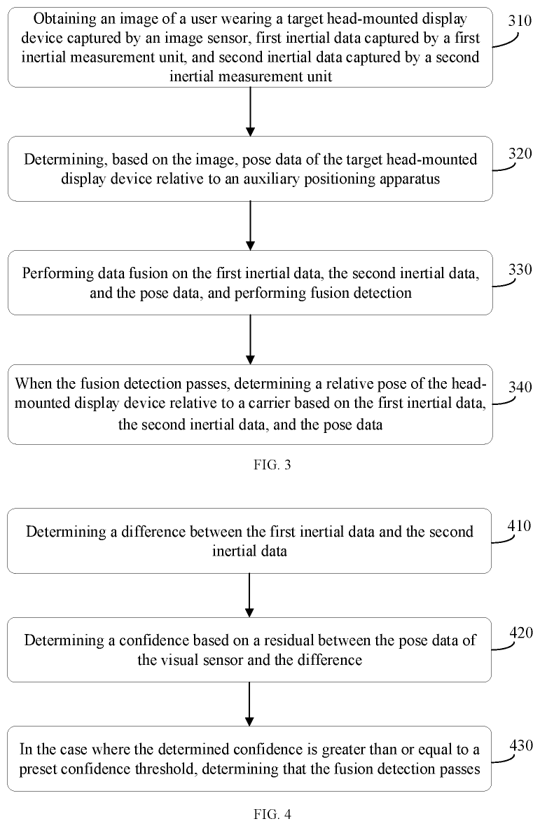

FIG. 3 illustrates a method for determining a relative pose in some embodiments of the present disclosure. As shown in FIG. 3, the method includes the following steps:

Step 310: obtaining an image of a user wearing a target head-mounted display device captured by an image sensor, first inertial data captured by a first inertial measurement unit, and second inertial data captured by a second inertial measurement unit.

In such embodiments, an auxiliary positioning apparatus and a target head-mounted display device corresponding to the auxiliary positioning apparatus are located inside a movable carrier, wherein the auxiliary positioning apparatus may be fixed to the carrier, and the auxiliary positioning apparatus may be provided with the image sensor and a first inertial measurement unit; and the target head-mounted display device may be provided with a second inertial measurement unit.

It is to be noted that the image sensor may be provided on a body of the auxiliary positioning apparatus, and in this case, the auxiliary positioning apparatus and the image sensor may form an integrated device. Alternatively, the image sensor may be provided outside the body of the auxiliary positioning apparatus, and in this case, the auxiliary positioning apparatus and the image sensor may form a split-type device. The image sensor and the auxiliary positioning apparatus may be fixed inside the carrier, and the image sensor is communicatively connected to the auxiliary positioning apparatus.

When the user wearing the target head-mounted display device is located inside the movable carrier, the image sensor of the auxiliary positioning apparatus may photograph an image of the user. At the same time, the first inertial measurement unit and the second inertial measurement unit may respectively acquire the first inertial data of the auxiliary positioning apparatus and the second inertial data of the head-mounted display device, which may be, for example, a three-axis attitude angular velocity and acceleration.

As an example, the first inertial measurement unit and the second inertial measurement unit may be inertial measurement units (IMUs).

It is to be noted that the image of the user wearing the target head-mounted display device captured by the image sensor should include at least an image of a head region of the user. It may be understood that the image captured by the image sensor may not include the target head-mounted display device.

Step 320: determining, based on the image, pose data of the target head-mounted display device relative to an auxiliary positioning apparatus.

In such embodiments, the pose data of the target head-mounted display device relative to the auxiliary positioning apparatus may be used in combination with inertial data obtained in a subsequent step to determine a relative pose of the target head-mounted display device relative to the carrier.

As an example, the image may be identified by using a pre-trained attitude identification model (which may be, for example, a convolutional neural network, a residual network, etc.) to determine a pose of at least one head-mounted display device in the image relative to the auxiliary positioning apparatus, and at least one pose obtained is used as the pose data of the target head-mounted display device relative to the auxiliary positioning apparatus.

Step 330: performing data fusion on the first inertial data, the second inertial data, and the pose data, and performing fusion detection.

In such embodiments, the fusion detection passing indicates that a usable pose is present in the pose data, i.e., a pose of the target head-mounted display device associated with the auxiliary positioning apparatus is present. The fusion detection failing indicates that no usable pose is present in the pose data, i.e., no head-mounted display device in the image is associated with the auxiliary positioning apparatus.

Here, the fusion detection may be performed in various ways. As an example, a difference between the first inertial data and the second inertial data may be first determined, then a confidence may be calculated based on a residual between the pose data and the difference, and then whether the fusion detection passes may be determined based on the confidence. Alternatively, for a detected optical marker position shown in the image and a predicted optical marker position for the target auxiliary positioning apparatus, a residual of a pixel difference therebetween may be calculated to determine a confidence, and then whether the fusion detection passes may be determined based on the confidence.

Step 340: when the fusion detection passes, determining a relative pose of the head-mounted display device relative to a carrier based on the first inertial data, the second inertial data, and the pose data.

As an example, the pose data, the first inertial data, and the second inertial data may be fused by using an EKF (Extended Kalman Filter) method or a Gauss-Newton optimization method or by constructing a nonlinear least squares problem, to determine the relative pose of the head-mounted display device relative to the carrier.

In such embodiments, a new method for determining a relative pose is proposed, in which an image of a user wearing a head-mounted display device is photographed by an image sensor provided on an auxiliary positioning apparatus, and pose data of the head-mounted display device relative to the auxiliary positioning apparatus is predicted, then fusion detection is performed on first inertial data of the auxiliary positioning apparatus, second inertial data of the head-mounted display device, and the pose data, and when the detection passes, a relative pose of the head-mounted display device relative to a carrier may be determined by using a multi-sensor data fusion method. In this way, the identification conflict problem that occurs when a plurality of users use auxiliary positioning apparatuses and head-mounted display devices at the same time can be solved, thus improving the accuracy of the determined relative pose, and helping improve a processing effect of subsequent image rendering based on the relative pose.

Next, reference is made to FIG. 4, which illustrates a flow diagram of fusion detection in some embodiments of the method for determining a relative pose in the present disclosure. As shown in FIG. 4, the process includes the following steps:

Step 410: determining a difference between the first inertial data and the second inertial data.

Step 420: determining a confidence based on a residual between the pose data of the visual sensor and the difference.

Step 430: in the case where the determined confidence is greater than or equal to a preset confidence threshold, determining that the fusion detection passes.

In a specific example, the image captured by the image sensor may include 3 head-mounted display devices. The pose data obtained by step 320 may include 3 poses. Subsequently, a residual between each of the 3 poses and the difference between the first inertial data and the second inertial data is determined respectively, and a confidence corresponding to each of the 3 poses is determined respectively. When one or more of the 3 confidences is not less than the confidence threshold, it indicates that there is a usable pose (i.e., a pose of the head-mounted display device relative to the target auxiliary positioning apparatus) among the 3 poses, and it can be determined that the fusion detection passes. When no confidence among the 3 confidences is greater than or equal to the confidence threshold, it indicates that there is no usable pose among the 3 poses, i.e., none of the 3 poses is the pose of the target head-mounted display device relative to the auxiliary positioning apparatus, and it can be determined that the fusion detection fails.

In such embodiments, a confidence may be determined based on a residual between the pose data and a difference between the inertial data, and whether the fusion detection passes may be determined based on the confidence. The image data captured by the image sensor is detected by using the inertial data, to ensure the accuracy and reliability of the pose data.

In some optional embodiments, when a plurality of head-mounted display devices are included in the image, poses of the plurality of head-mounted display devices relative to the auxiliary positioning apparatus are respectively determined to obtain a plurality of candidate poses.

When a plurality of head-mounted display devices are simultaneously present inside the carrier, a plurality of head-mounted display devices are usually included in the image captured by the image sensor. In order to prevent the pose of the target head-mounted display device from being missed, poses of the plurality of head-mounted display devices relative to the auxiliary positioning apparatus may be determined respectively to obtain a plurality of candidate poses as pose data of the target head-mounted display device.

Further, the plurality of candidate poses may be determined by the following steps: identifying the image using a pre-trained identification model to determine at least one user included in the image; and for a user of the identified at least one user, in response to the user wearing a head-mounted display device, determining a head pose of the user as a candidate pose corresponding to the user, thereby obtaining the plurality of candidate poses.

In such embodiments, head images of a plurality of users may be identified from the image using the identification model, and a head pose of a user wearing a head-mounted display device may be identified as a candidate pose of the user, thereby obtaining the plurality of candidate poses. This can improve the computing efficiency and accuracy of calculating the candidate poses, and avoid wasting computing resources.

Optionally, in response to the user not wearing a head-mounted display device, tracking of the head pose of the user may be abandoned to avoid wasting computing resources.

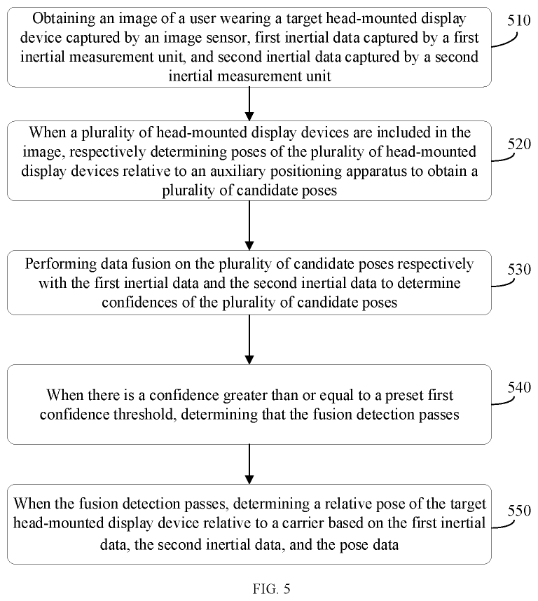

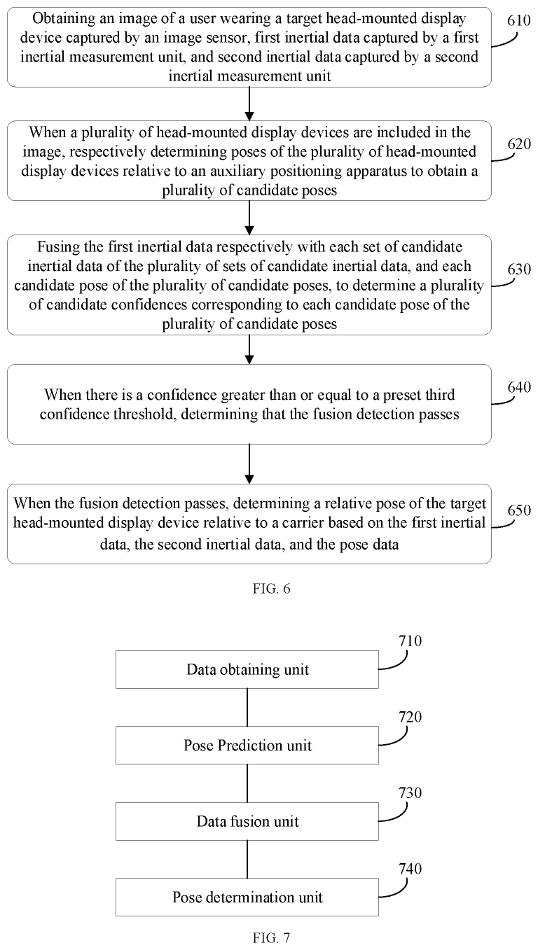

Next, reference is made to FIG. 5, which illustrates a flow diagram of some embodiments of determining a relative pose in the present disclosure. As shown in FIG. 5, the process includes the following steps:

Step 510: obtaining an image of a user wearing a target head-mounted display device captured by an image sensor, first inertial data captured by a first inertial measurement unit, and second inertial data captured by a second inertial measurement unit.

In such embodiments, an auxiliary positioning apparatus is in one-to-one correspondence with a target head-mounted display device, that is, each auxiliary positioning apparatus can only perform data interaction with the target head-mounted display device corresponding thereto. For example, the auxiliary positioning apparatus can only obtain data of the target head-mounted display device, and/or send data to the target head-mounted display device, and cannot perform data interaction with other head-mounted display devices.

Step 520: when a plurality of head-mounted display devices are included in the image, respectively determining poses of the plurality of head-mounted display devices relative to an auxiliary positioning apparatus to obtain a plurality of candidate poses.

Step 530: performing data fusion on the plurality of candidate poses respectively with the first inertial data and the second inertial data to determine confidences of the plurality of candidate poses. Step 540: when there is a confidence greater than or equal to a preset first confidence threshold, determining that the fusion detection passes.

Step 550: when the fusion detection passes, determining a relative pose of the target head-mounted display device relative to a carrier based on the first inertial data, the second inertial data, and the pose data.

In a specific example, there may be a total of 4 groups of auxiliary positioning apparatuses and head-mounted display devices inside the carrier, and the auxiliary positioning apparatuses are in one-to-one correspondence with the head-mounted display devices. For any one of the groups of auxiliary positioning apparatuses and head-mounted display devices, the auxiliary positioning apparatus can only receive second inertial data of the head-mounted display device corresponding thereto. In this example, there may be at most 4 head-mounted display devices in the image captured by the image sensor. Through step 520, 4 candidate poses may be obtained, then the 4 candidate poses are respectively fused with the first inertial data and the second inertial data, and 4 confidences may be obtained. When one or more of the 4 confidences is greater than or equal to the first confidence threshold, it may indicate that the 4 candidate poses include a pose of the head-mounted display device corresponding to the auxiliary positioning apparatus, and in this case, it can be determined that the fusion detection passes. Subsequently, a candidate pose with the highest confidence may be selected therefrom and fused with the first inertial data and the second inertial data to determine a relative pose of the head-mounted display device corresponding to the auxiliary positioning apparatus relative to the carrier.

In the embodiment shown in FIG. 5, when a plurality of groups of one-to-one corresponding auxiliary positioning apparatuses and head-mounted display devices are present in the carrier, fusion detection may be performed respectively on the plurality of candidate poses with the first inertial data and the second inertial data, to determine whether a pose of the head-mounted display device corresponding to the auxiliary positioning apparatus is included in the candidate poses, and to determine a pose of the head-mounted display device corresponding to each auxiliary positioning apparatus, thereby determining, through data fusion, a relative pose of the head-mounted display device corresponding to each auxiliary positioning apparatus relative to the carrier. This can resolve an identification conflict between head-mounted display devices when a plurality of groups of auxiliary positioning apparatuses and the head-mounted display device in one-to-one correspondence are used at the same time, and can help improve the accuracy of calculating the relative pose.

In some optional implementations of the embodiment shown in FIG. 5, before step 550, the method further includes: determining a candidate pose with the highest confidence as pose data of the target head-mounted display device relative to the auxiliary positioning apparatus.

In such embodiments, a confidence may indicate a matching degree between a candidate pose and the auxiliary positioning apparatus. A head-mounted display device corresponding to the candidate pose with the highest confidence has the highest matching degree with the auxiliary positioning apparatus, indicating that the probability of correspondence between the head-mounted display device and the auxiliary positioning apparatus is the greatest. By determining the candidate pose with the highest confidence as the pose data of the target head-mounted display device relative to the auxiliary positioning apparatus, the pose data of the target head-mounted display device corresponding to the auxiliary positioning apparatus can be more accurately identified from the image, and the pose data is subsequently fused with the first inertial data and the second inertial data to determine the relative pose of the target head-mounted display device relative to the carrier, which further improves the precision of the calculation of the relative pose.

In some optional implementations of the embodiment shown in FIG. 5, the method further includes: abandoning tracking of a head pose of the user if the confidence of the candidate pose corresponding to the user is less than a preset second confidence threshold.

In such embodiments, a lower confidence of the candidate pose corresponding to the user indicates a lower probability of correspondence between the head-mounted display device worn by the user and the auxiliary positioning apparatus. When the confidence of the candidate pose corresponding to the user is less than the preset second confidence threshold, it indicates that the value of the candidate pose corresponding to the user is negligible in the subsequent step, and in this case, the tracking of the head pose of the user can be abandoned, so as not to cause a waste of computing resources.

Next, reference is made to FIG. 6, which illustrates a flow diagram of some embodiments of a method for determining a relative pose in the present disclosure. As shown in FIG. 6, the process includes the following steps:

Step 610: obtaining an image of a user wearing a target head-mounted display device captured by an image sensor, first inertial data captured by a first inertial measurement unit, and second inertial data captured by a second inertial measurement unit.

In such embodiments, an auxiliary positioning apparatus corresponds to a plurality of target head-mounted devices. In this case, the second inertial data should include inertial data captured by second inertial measurement units of the plurality of target head-mounted devices.

Optionally, the second inertial data may be obtained in the following manner: obtaining inertial data captured respectively by a plurality of second inertial measurement units corresponding to the plurality of head-mounted display devices to obtain a plurality of sets of candidate inertial data as the second inertial data.

The auxiliary positioning apparatus corresponding to a plurality of target head-mounted devices indicates that the auxiliary positioning apparatus may simultaneously perform data interaction with the plurality of head-mounted display devices. For example, the auxiliary positioning apparatus may obtain the candidate inertial data of the plurality of head-mounted display devices, and respectively determine relative poses of the plurality of head-mounted display devices relative to a carrier.

It may be understood that after the auxiliary positioning apparatus receives the candidate inertial data of the plurality of head-mounted display devices, correspondence between the candidate inertial data and the poses of the plurality of head-mounted display devices cannot yet be determined, and thus the relative poses of the plurality of head-mounted display devices relative to the carrier cannot yet be determined through data fusion.

Step 620: when a plurality of head-mounted display devices are included in the image, respectively determining poses of the plurality of head-mounted display devices relative to an auxiliary positioning apparatus to obtain a plurality of candidate poses.

Step 630: fusing the first inertial data respectively with each set of candidate inertial data of the plurality of sets of candidate inertial data, and each candidate pose of the plurality of candidate poses, to determine a plurality of candidate confidences corresponding to each candidate pose of the plurality of candidate poses.

In such embodiments, the plurality of candidate poses may be combined in permutations with the plurality of sets of candidate inertial data, and then fusion detection may be performed on each combination respectively with the first inertial data to obtain a candidate confidence corresponding to each combination. For example, assume that the candidate inertia data obtained in step 610 includes candidate inertia data a, and candidate inertia data b, and the candidate poses obtained in step 620 include a candidate pose 1, and a candidate pose 2. Then, the following combinations may be obtained: (a, 1), (a, 2), (b, 1), and (b, 2). After each combination is respectively fused with the first inertia data, corresponding 4 candidate confidences may be obtained: A, B, C, and D, wherein candidate confidences corresponding to the candidate pose 1 are A and C, and candidate confidences corresponding to the candidate pose 2 are B and D.

In such embodiments, a matching degree between a candidate pose and second inertial data may be characterized in a candidate confidence. For any group of candidate pose and candidate inertial data, if the candidate inertial data and the candidate pose belong to the same head-mounted display device, a matching degree between the candidate pose and the candidate inertial data will be higher, and correspondingly, a candidate confidence corresponding to the combination will be higher. Conversely, if the candidate inertial data and the candidate pose belong to different head-mounted display devices, the matching degree between the candidate pose and the candidate inertial data will be lower, and correspondingly, the candidate confidence corresponding to the combination will be lower.

Step 640: when there is a confidence greater than or equal to a preset third confidence threshold, determining that the fusion detection passes.

In such embodiments, when there is a candidate confidence greater than or equal to the preset third confidence threshold, it indicates that the plurality of combinations obtained during the fusion detection in step 630 include a valid combination of a candidate pose and candidate inertial data (i.e., a combination consisting of a candidate pose and candidate inertial data of the same head-mounted display device).

Step 650: when the fusion detection passes, determining a relative pose of the target head-mounted display device relative to a carrier based on the first inertial data, the second inertial data, and the pose data.

In a specific example, the auxiliary positioning apparatus corresponds to 5 head-mounted display devices simultaneously. Accordingly, the second inertial data includes 5 sets of candidate inertial data, and 5 candidate poses can be obtained in step 620. Subsequently, the 5 candidate poses may be combined in permutations with the 5 sets of candidate inertial data to obtain 25 combinations, and then fusion detection may be performed on the 25 combinations respectively with the first inertial data to obtain 25 candidate confidences. If any of the 25 candidate confidences is greater than or equal to the preset third confidence threshold, the fusion detection passes. At this point, based on the 25 candidate confidences, the highest candidate confidence corresponding to each candidate pose may be selected, and the candidate pose and candidate inertial data corresponding to the candidate confidence may be determined to be in correspondence. In this way, candidate poses respectively corresponding to the plurality of sets of candidate inertial data may be determined. Then, the first inertial data may be fused with candidate inertial data and a candidate pose that are in correspondence, thereby determining the relative pose of the head-mounted display device corresponding to the candidate inertial data relative to the carrier.

In the embodiment shown in FIG. 6, the first inertial data is fused respectively with each set of candidate inertial data of the plurality of sets of candidate inertial data, and each candidate pose of the plurality of candidate poses, to determine a plurality of candidate confidences corresponding to each candidate pose of the plurality of candidate poses. A candidate confidence is used to characterize a matching degree between a candidate pose and candidate inertia data, so as to determine a candidate pose and candidate inertia data corresponding to each head-mounted display device. This can solve the identification conflict problem that occurs when the auxiliary positioning apparatus corresponds to a plurality of head-mounted display devices simultaneously, and help improve the calculation accuracy of the relative pose.

In some optional implementations of the embodiment shown in FIG. 6, step 650 described above includes: determining a head-mounted display device corresponding to each candidate pose of the plurality of candidate poses based on candidate inertial data corresponding to the highest candidate confidence of each candidate pose of the plurality of candidate poses; and respectively determining a relative pose of each head-mounted display device of the plurality of head-mounted display devices relative to the carrier based on the first inertial data, a candidate pose corresponding to each head-mounted display device of the plurality of head-mounted display devices, and the candidate inertial data corresponding to the candidate pose. In this case, each head-mounted display device of the plurality of head-mounted display devices described above may be the target head-mounted display device.

Continuing with the description in conjunction with the example in step 630, assuming that the 4 candidate confidences A, B, C, and D take the values of 0.7, 0.8, 0.9, and 0.6, respectively, the highest candidate confidence corresponding to the candidate pose 1 is C, which corresponds to the combination (b, 1); and the highest candidate confidence corresponding to the candidate pose 2 is B, which corresponds to the combination (a, 2). Accordingly, a head-mounted display device corresponding to the candidate pose 1 is a head-mounted display device corresponding to the candidate inertial data b, and a head-mounted display device corresponding to the candidate pose 2 is a head-mounted display device corresponding to the candidate inertial data a.

In such implementations, correspondence between a candidate pose and candidate inertial data may be determined based on a candidate confidence, which ensures correspondence between pose data and inertial data when data fusion is performed, and helps improve the calculation accuracy of the relative pose.

In some optional implementations of the embodiment shown in FIG. 6, the method further includes: abandoning tracking of a head pose of the user if a plurality of candidate confidences corresponding to the user are all less than a preset fourth confidence threshold.

In such implementations, if the plurality of candidate confidences corresponding to the user are all less than the preset fourth confidence threshold, it indicates that the user is an invalid user, that is, the head-mounted display device worn by the user is not a head-mounted display device corresponding to the auxiliary positioning apparatus. In this case, tracking of the head pose of the user is abandoned to avoid the introduction of interfering data and the waste of computing resources. In some embodiments, after obtaining the relative pose, the method further includes: sending the relative pose to the target head-mounted display device, so that the target head-mounted display device performs rendering processing based on the relative pose.

In such embodiments, the auxiliary positioning apparatus may send the relative pose obtained by calculation to the corresponding head-mounted display device, so that the target head-mounted display device performs rendering processing based on the relative pose, to allow the quality of the rendering processing to be improved by using the high-precision relative pose.

### Exemplary Apparatus

In the following, reference is made to FIG. 7, which shows a schematic structural diagram of an embodiment of an apparatus for determining a relative pose in the present disclosure. An auxiliary positioning apparatus and a target head-mounted display device corresponding to the auxiliary positioning apparatus are located inside a movable carrier. The auxiliary positioning apparatus is fixedly connected to the carrier and provided with an image sensor and a first inertial measurement unit; and the target head-mounted display device is provided with a second inertial measurement unit. The apparatus includes: a data obtaining unit 710 configured to obtain an image of a user wearing a target head-mounted display device captured by an image sensor, first inertial data captured by a first inertial measurement unit, and second inertial data captured by a second inertial measurement unit; a pose prediction unit 720 configured to determine, based on the image, pose data of the target head-mounted display device relative to the auxiliary positioning apparatus; a data fusion unit 730 configured to perform data fusion on the first inertial data, the second inertial data, and the pose data, and perform fusion detection; and a pose determination unit 740 configured to, when the fusion detection passes, determine a relative pose of the target head-mounted display device relative to the carrier based on the first inertial data, the second inertial data, and the pose data.

In one implementation, the fusion detection unit 730 includes: a first calculation module configured to determine a difference between the first inertial data and the second inertial data; a second calculation module configured to determine a confidence based on a residual between the pose data and the difference; and a detection module configured to determine that the fusion detection passes in the case where the determined confidence is greater than or equal to a preset confidence threshold.

In one implementation, the pose determination unit 740 is further configured to: when a plurality of head-mounted display devices are included in the image, respectively determine poses of the plurality of head-mounted display devices relative to the auxiliary positioning apparatus to obtain a plurality of candidate poses.

In one implementation, the pose determination unit 740 is further configured to: identify the image using a pre-trained identification model to determine at least one user included in the image; and for a user of the identified at least one user, in response to the user wearing a head-mounted display device, determine a head pose of the user as a candidate pose corresponding to the user, thereby obtaining the plurality of candidate poses.

In one implementation, the auxiliary positioning apparatus is in one-to-one correspondence with the target head-mounted display device; and the data fusion unit further includes: a first fusion module configured to perform data fusion on the plurality of candidate poses respectively with the first inertial data and the second inertial data to determine confidences of the plurality of candidate poses; and a first judgment module configured to, when there is a confidence greater than or equal to a preset first confidence threshold, determine that the fusion detection passes.

In one implementation, the apparatus further includes a data determination unit configured to determine a candidate pose with the highest confidence as pose data of the target head-mounted display device relative to the auxiliary positioning apparatus.

In one implementation, the apparatus further includes a first tracking module configured to abandon tracking of the head pose of the user if the confidence of the candidate pose corresponding to the user is less than a preset second confidence threshold.

In one implementation, the auxiliary positioning apparatus corresponds to a plurality of target head-mounted devices; and the second inertial data may be obtained in the following manner: obtaining inertial data captured respectively by a plurality of second inertial measurement units corresponding to the plurality of head-mounted display devices to obtain a plurality of sets of candidate inertial data as the second inertial data.

In one implementation, the data fusion unit 730 includes: a second fusion module configured to fuse the first inertial data respectively with each set of candidate inertial data of the plurality of sets of candidate inertial data, and each candidate pose of the plurality of candidate poses, to determine a plurality of candidate confidences corresponding to each candidate pose of the plurality of candidate poses; and a second judgment module configured to, when there is a confidence greater than or equal to a preset third confidence threshold, determine that the fusion detection passes.

In one implementation, the pose determination unit 740 further includes: a determination module configured to determine a head-mounted display device corresponding to each candidate pose of the plurality of candidate poses based on candidate inertial data corresponding to the highest candidate confidence of each candidate pose of the plurality of candidate poses; and a pose calculation module configured to respectively determine a relative pose of each head-mounted display device of the plurality of head-mounted display devices relative to the carrier based on the first inertial data, a candidate pose corresponding to each head-mounted display device of the plurality of head-mounted display devices, and the candidate inertial data corresponding to the candidate pose.

In one implementation, the apparatus further includes a second tracking unit configured to abandon tracking of the head pose of the user if a plurality of candidate confidences corresponding to the user are all less than a preset fourth confidence threshold.

In one implementation, the apparatus further includes a sending unit configured to send the relative pose to the target head-mounted display device, so that the target head-mounted display device performs rendering processing based on the relative pose.

### Exemplary Electronic Device

In addition, an embodiment of the present disclosure further provides an electronic device, including:
a memory configured to store a computer program; and
a processor configured to execute the computer program stored in the memory, wherein the computer program, when executed, implements the method for determining a relative pose according to any of the above embodiments of the present disclosure.

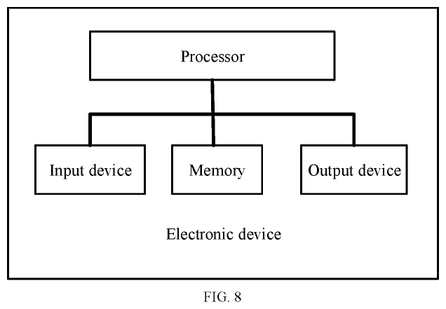

FIG. 8 is a schematic structural diagram of an application embodiment of an electronic device of the present disclosure. An electronic device according to an embodiment of the present disclosure will be described below with reference to FIG. 8. As shown in FIG. 8, the electronic device includes one or more processors and a memory.

The processor may be a central processing unit (CPU) or other form of processing unit having data processing capabilities and/or instruction execution capabilities, and may control other components in the electronic device to perform desired functions.

The memory may include one or more computer program products. The computer program products may include various forms of computer-readable storage media, such as a volatile memory and/or a non-volatile memory. The volatile memory may, for example, include random access memory (RAM) and/or a cache memory (cache), etc. The non-volatile memory may, for example, include a read-only memory (ROM), a hard disk, a flash memory, etc. One or more computer program instructions may be stored on the computer-readable storage medium, and the processor may execute the program instructions to implement the method for determining a relative pose in embodiments of the present disclosure described above and/or other desired functions.

In an example, the electronic device may further include an input device and an output device. The components are interconnected via a bus system and/or other forms of connecting mechanisms (not shown).

In addition, the input device may further include, for example, a keyboard, a mouse, and the like.

The output device may output various information to the outside, including determined distance information, direction information, etc. The output device may include, for example, a display, a speaker, a printer, and a communications network and a remote output device connected thereto, and so on.

Of course, for simplicity, only some of components of the electronic device relevant to the present disclosure are shown in FIG. 8, while components such as buses, input/output interfaces, and the like are omitted. In addition, depending on a specific application, the electronic device may further include any other appropriate components.

In addition to the method and device described above, embodiments of the present disclosure may also be a computer program product including computer program instructions. The computer program instructions, when executed by a processor, cause the processor to execute the steps of the method for determining a relative pose according to various embodiments of the present disclosure as described in the above section of this specification.

The computer program product may use any combination of one or more programming languages to write program code for performing operations of the embodiments of the present disclosure. The programming languages include an object-oriented programming language such as Java or C++, and also include a conventional procedural programming language, such as “C” language or a similar programming language. The program code may be executed entirely on a user's computing device, partly on a user's device, as an independent software package, partly on a user's computing device and partly on a remote computing device, or entirely on a remote computing device or server.

In addition, embodiments of the present disclosure may also be a computer-readable storage medium configured to store computer program instructions therein. The computer program instructions, when executed by a processor, cause the processor to execute the steps of the method for determining a relative pose according to various embodiments of the present disclosure as described in the above section of this specification.

The computer-readable storage medium may be any combination of one or more readable media. The readable medium may be a readable signal medium or a readable storage medium. The readable storage medium may include, for example, but is not limited to, an electronic, magnetic, optical, electromagnetic, infrared, or semiconductor system, apparatus or device, or any combination thereof. More specific examples (a non-exhaustive list) of the readable storage medium include: an electrical connection with one or more conducting wires, a portable disk, a hard disk, a random access memory (RAM), a read only memory (ROM), an erasable programmable read only memory (EPROM or flash memory), an optical fiber, a portable compact disk read only memory(CD-ROM), an optical storage device, a magnetic storage device, or any suitable combination thereof.

Those of ordinary skill in the art can understand that all or part of the steps in the above method embodiment may be implemented by hardware related to program instructions. The aforementioned program may be stored on a computer-readable storage medium. When the program is executed, the steps included in the above method embodiment are executed. The aforementioned storage medium includes: a ROM, a RAM, a magnetic disk or optical disk, or any of various media capable of storing program codes.

Basic principles of the present disclosure are described above in conjunction with specific embodiments. However, it is to be noted that the advantages, strengths, effects, and the like mentioned in the present disclosure are only examples and not limitations, and these advantages, strengths, effects, and the like should not be regarded as indispensable for the embodiments of the present disclosure. In addition, the specific details in the above disclosure are only for the purposes of exemplification and ease of understanding, and are not limiting. The above details do not constrain the present disclosure to be necessarily implemented with the above specific details.

The embodiments in the specification are described in a progressive manner. Each embodiment focuses on differences from other embodiments. For the same and similar parts between the embodiments, reference can be made to each other. A system embodiment, which substantially corresponds to a method embodiment, is described relatively simply, and for its relevant parts, reference may be made to parts of description of the method embodiment.

Block diagrams of devices, apparatuses, equipment, and systems involved in the present disclosure are only used as illustrative examples and are not intended to require or imply that they are necessarily connected, arranged, or configured in the manner illustrated in the block diagrams. As will be recognized by those skilled in the art, these devices, apparatuses, equipment, and systems may be connected, arranged, or configured in any manner. Words such as “include”, “comprise”, “have”, etc. are open-ended terms, mean “include but not limited to” and may be used interchangeably. The words “or” and “and” as used herein refer to the words “and/or”, and may be used interchangeably therewith unless the context clearly indicates otherwise. The word “such as” as used herein refers to the phrase “such as, but not limited to”, and may be used interchangeably therewith.

The method and apparatus of the present disclosure may be implemented in many ways. For example, the method and apparatus of the present disclosure may be implemented by software, hardware, firmware, or any combination of software, hardware, and firmware. The above order for the steps of the described method is only for an illustrative purpose, and the steps of the methods of the present disclosure are not limited to the order specifically described above, unless otherwise specified. Additionally, in some embodiments, the present disclosure may also be implemented as programs recorded in a recording medium. The programs include machine-readable instructions for implementing the method according to the present disclosure. Thus, the present disclosure also covers a recording medium that stores programs for performing the method according to the present disclosure.

It is also to be noted that in the apparatus, device, and method of the present disclosure, the components or steps are decomposable and/or recombinable. These decompositions and/or recombinations should be considered as equivalents of the present disclosure.

The above description of the disclosed aspects is provided to enable any person skilled in the art to carry out or use the present disclosure. Various modifications to these aspects are very apparent to those skilled in the art, and general principles defined herein may be applied to other aspects without departing from the scope of the present disclosure. Accordingly, the present disclosure is not intended to be limited to the aspects illustrated herein, but rather in accordance with the broadest scope consistent with the principles and novel features disclosed herein.

The above description has been made for purposes of illustration and description. In addition, this description is not intended to limit the embodiments of the present disclosure to the forms disclosed herein. Although a plurality of example aspects and embodiments have been discussed above, certain variations, modifications, changes, additions, and sub-combinations thereof would occur to those skilled in the art.

1. A method for determining a relative pose, wherein an auxiliary positioning apparatus and a target head-mounted display device corresponding to the auxiliary positioning apparatus are located inside a movable carrier, the auxiliary positioning apparatus being configured to be fixedly connected to the carrier and being provided with an image sensor and a first inertial measurement unit, and the target head-mounted display device being provided with a second inertial measurement unit, the method comprising:
obtaining an image, captured by the image sensor, of a user wearing the target head-mounted display device, first inertial data captured by the first inertial measurement unit, and second inertial data captured by the second inertial measurement unit;
determining, based on the image, pose data of the target head-mounted display device relative to the auxiliary positioning apparatus;
performing data fusion on the first inertial data, the second inertial data, and the pose data, and performing fusion detection; and
when the fusion detection passes, determining a relative pose of the target head-mounted display device relative to the carrier based on the first inertial data, the second inertial data, and the pose data.

2. The method according to claim 1, wherein performing data fusion on the first inertial data, the second inertial data, and the pose data, and performing fusion detection comprises:
determining a difference between the first inertial data and the second inertial data;
determining a confidence based on a residual between the pose data and the difference; and
in the case where a determined confidence is greater than or equal to a preset confidence threshold, determining that the fusion detection passes.

3. The method according to claim 1, wherein determining, based on the image, pose data of the target head-mounted display device relative to the auxiliary positioning apparatus comprises:
when a plurality of head-mounted display devices are included in the image, respectively determining poses of the plurality of head-mounted display devices relative to the auxiliary positioning apparatus to obtain a plurality of candidate poses.

4. The method according to claim 3, wherein when a plurality of head-mounted display devices are included in the image, respectively determining poses of the plurality of head-mounted display devices relative to the auxiliary positioning apparatus to obtain a plurality of candidate poses comprises:
identifying the image using a pre-trained identification model to determine at least one user included in the image; and
for a user of the identified at least one user, in response to the user wearing a head-mounted display device, determining a head pose of the user as a candidate pose corresponding to the user, to obtain the plurality of candidate poses.

5. The method according to claim 3, wherein the auxiliary positioning apparatus is in one-to-one correspondence with the target head-mounted display device; and
performing data fusion on the first inertial data, the second inertial data, and the pose data, and performing fusion detection comprises:
performing data fusion on the plurality of candidate poses respectively with the first inertial data and the second inertial data to determine confidences of the plurality of candidate poses; and
when there is a confidence greater than or equal to a preset first confidence threshold, determining that the fusion detection passes.

6. The method according to claim 3, wherein before determining a relative pose of the target head-mounted display device relative to the carrier based on the first inertial data, the second inertial data, and the pose data, the method further comprises:
determining a candidate pose with a highest confidence as the pose data of the target head-mounted display device relative to the auxiliary positioning apparatus.

7. The method according to claim 3, further comprising:
abandoning tracking of the head pose of the user if the confidence of the candidate pose corresponding to the user is less than a preset second confidence threshold.

8. The method according to claim 1, wherein the auxiliary positioning apparatus corresponds to a plurality of target head-mounted display devices; and
the second inertia data is obtained by:
obtaining inertial data captured respectively by a plurality of second inertial measurement units corresponding to the plurality of head-mounted display devices to obtain a plurality of sets of candidate inertial data as the second inertial data.

9. The method according to claim 8, wherein performing data fusion on the first inertial data, the second inertial data, and the pose data, and performing fusion detection comprises:
fusing the first inertial data respectively with each set of candidate inertial data of the plurality of sets of candidate inertial data, and each candidate pose of the plurality of candidate poses, to determine a plurality of candidate confidences corresponding to each candidate pose of the plurality of candidate poses; and
when there is a confidence greater than or equal to a preset third confidence threshold, determining that the fusion detection passes.

10. The method according to claim 9, wherein determining a relative pose of the target head-mounted display device relative to the carrier based on the first inertial data, the second inertial data, and the pose data comprises:
determining a head-mounted display device corresponding to each candidate pose of the plurality of candidate poses based on candidate inertial data corresponding to the highest candidate confidence of each candidate pose of the plurality of candidate poses; and
respectively determining a relative pose of each head-mounted display device of the plurality of head-mounted display devices relative to the carrier based on the first inertial data, a candidate pose corresponding to each head-mounted display device of the plurality of head-mounted display devices, and the candidate inertial data corresponding to the candidate pose.

11. The method according to claim 9, further comprising:
abandoning tracking of the head pose of the user if a plurality of candidate confidences corresponding to the user are all less than a preset fourth confidence threshold.

12. The method according to claim 1, further comprising:
sending the relative pose to the target head-mounted display device, so that the target head-mounted display device performs rendering process based on the relative pose.

13. An extended reality system comprising an auxiliary positioning apparatus, a head-mounted display device communicatively connected to the auxiliary positioning apparatus, and an apparatus for determining a relative pose of a target head-mounted display device relative to a movable carrier, wherein the head-mounted display device and the apparatus are located in the movable carrier, the auxiliary positioning apparatus is fixedly connected to the movable carrier and provided with an image sensor and a first inertial measurement unit, and the head-mounted display device is provided with a second inertial measurement unit; and
the apparatus for determining a relative pose is configured to:
obtain an image including at least one head-mounted display device captured by the image sensor, first inertial data of at least one target head-mounted display device, and second inertial data of the auxiliary positioning apparatus;
determine, based on the image, pose data of each head-mounted display device relative to the auxiliary positioning apparatus;
perform data fusion on the first inertial data, the second inertial data, and the pose data;
perform fusion detection, to determine whether a target head-mounted display device is included in the image; and
in the case where at least one target head-mounted display device is included in the image, determine a relative pose of each target head-mounted display device relative to the carrier based on the first inertial data of each target head-mounted display device, the second inertial data of the auxiliary positioning apparatus, and the determined pose data of each target head-mounted display device relative to the auxiliary positioning apparatus.

14. (canceled)

15. A computer-readable storage medium configured to store a computer program therein, wherein the computer program, when executed by a processor, implements the method for determining a relative pose, wherein an auxiliary positioning apparatus and a target head-mounted display device corresponding to the auxiliary positioning apparatus are located inside a movable carrier, the auxiliary positioning apparatus being configured to be fixedly connected to the carrier and being provided with an image sensor and a first inertial measurement unit, and the target head-mounted display device being provided with a second inertial measurement unit, the method comprising:
obtaining an image, captured by the image sensor, of a user wearing the target head-mounted display device, first inertial data captured by the first inertial measurement unit, and second inertial data captured by the second inertial measurement unit;
determining, based on the image, pose data of the target head-mounted display device relative to the auxiliary positioning apparatus;
performing data fusion on the first inertial data, the second inertial data, and the pose data, and performing fusion detection; and
when the fusion detection passes, determining a relative pose of the target head-mounted display device relative to the carrier based on the first inertial data, the second inertial data, and the pose data.

16. The computer-readable storage medium according to claim 15, wherein performing data fusion on the first inertial data, the second inertial data, and the pose data, and performing fusion detection comprises:
determining a difference between the first inertial data and the second inertial data;
determining a confidence based on a residual between the pose data and the difference; and
in the case where a determined confidence is greater than or equal to a preset confidence threshold, determining that the fusion detection passes.

17. The computer-readable storage medium according to claim 15, wherein determining, based on the image, pose data of the target head-mounted display device relative to the auxiliary positioning apparatus comprises:
when a plurality of head-mounted display devices are included in the image, respectively determining poses of the plurality of head-mounted display devices relative to the auxiliary positioning apparatus to obtain a plurality of candidate poses.

18. The computer-readable storage medium according to claim 17, wherein when a plurality of head-mounted display devices are included in the image, respectively determining poses of the plurality of head-mounted display devices relative to the auxiliary positioning apparatus to obtain a plurality of candidate poses comprises:
identifying the image using a pre-trained identification model to determine at least one user included in the image; and
for a user of the identified at least one user, in response to the user wearing a head-mounted display device, determining a head pose of the user as a candidate pose corresponding to the user, to obtain the plurality of candidate poses.

19. The computer-readable storage medium according to claim 17, wherein the auxiliary positioning apparatus is in one-to-one correspondence with the target head-mounted display device; and
performing data fusion on the first inertial data, the second inertial data, and the pose data, and performing fusion detection comprises:
performing data fusion on the plurality of candidate poses respectively with the first inertial data and the second inertial data to determine confidences of the plurality of candidate poses; and
when there is a confidence greater than or equal to a preset first confidence threshold, determining that the fusion detection passes.

20. The computer-readable storage medium according to claim 17, wherein before determining a relative pose of the target head-mounted display device relative to the carrier based on the first inertial data, the second inertial data, and the pose data, the method further comprises:
determining a candidate pose with a highest confidence as the pose data of the target head-mounted display device relative to the auxiliary positioning apparatus.

21. The computer-readable storage medium according to claim 17, wherein the method further comprises:
abandoning tracking of the head pose of the user if the confidence of the candidate pose corresponding to the user is less than a preset second confidence threshold.
